(19) United States
(12) Patent Application Publication
(10) Pub. No.: US 2025/0193026 A1
(43) Pub. Date: Jun. 12, 2025

(54) TRANSLUCENT BLOCKCHAIN DATABASE

(71) Applicant: nChain Licensing AG, Zug (CH)

(72) Inventors: Bassem AMMAR, London (GB); Craig Steven WRIGHT, London (GB)

(21) Appl. No.: 18/844,865

(22) PCT Filed: Feb. 28, 2023
(86) PCT No.: PCT/EP2023/054917

§ 371 Date: Sep. 6, 2024

(30) Foreign Application Priority Data
Mar. 8, 2022 (GB) 2203174.4

(51) Int. Cl. H04L 9/32; G06F 16/22; H04L 9/00

(52) U.S. Cl. CPC H04L 9/3265; G06F 16/2246; H04L 9/3247; H04L 9/50

(57) ABSTRACT

A computer-implemented method comprising: obtaining information describing a property; dividing the information into at least two data items describing the property at at least two different levels of precision; obtaining a set of data items for generating a Merkle tree, the set of data items including the at least two data items; generating two or more leaf nodes of a Merkle tree by hashing each data item in the set of data items, wherein the Merkle tree comprises a plurality of leaf nodes including the two or more leaf nodes; and storing at least one of: the Merkle tree; instructions for generating the Merkle tree from the set of data items.

### CROSS REFERENCE TO RELATED APPLICATIONS

This application is the U.S. National Stage of International Application No. PCT/EP2023/054917 filed on Feb. 28, 2023, which claims the benefit of United Kingdom Patent Application No. 2203174.4, filed on Mar. 8, 2022, the contents of which are incorporated herein by reference in their entireties.

### TECHNICAL FIELD

The present disclosure relates to a method for storing data in a secure manner.

### BACKGROUND

A blockchain refers to a form of distributed data structure, wherein a duplicate copy of the blockchain is maintained at each of a plurality of nodes in a distributed peer-to-peer (P2P) network (referred to below as a “blockchain network”) and widely publicised. The blockchain comprises a chain of blocks of data, wherein each block comprises one or more transactions. Each transaction, other than so-called “coinbase transactions”, points back to a preceding transaction in a sequence which may span one or more blocks going back to one or more coinbase transactions. Coinbase transactions are discussed further below. Transactions that are submitted to the blockchain network are included in new blocks. New blocks are created by a process often referred to as “mining”, which involves each of a plurality of the nodes competing to perform “proof-of-work”, i.e., solving a cryptographic puzzle based on a representation of a defined set of ordered and validated pending transactions waiting to be included in a new block of the blockchain. It should be noted that the blockchain may be pruned at some nodes, and the publication of blocks can be achieved through the publication of mere block headers.

The transactions in the blockchain may be used for one or more of the following purposes: to convey a digital asset (i.e., a number of digital tokens), to order a set of entries in a virtualised ledger or registry, to receive and process timestamp entries, and/or to time-order index pointers. A blockchain can also be exploited in order to layer additional functionality on top of the blockchain. For example, blockchain protocols may allow for storage of additional user data or indexes to data in a transaction. There is no pre-specified limit to the maximum data capacity that can be stored within a single transaction, and therefore increasingly more complex data can be incorporated. For instance, this may be used to store an electronic document in the blockchain, or audio or video data.

Nodes of the blockchain network (which are often referred to as “miners”) perform a distributed transaction registration and verification process, which will be described in more detail later. In summary, during this process a node validates transactions and inserts them into a block template for which they attempt to identify a valid proof-of-work solution. Once a valid solution is found, a new block is propagated to other nodes of the network, thus enabling each node to record the new block on the blockchain. In order to have a transaction recorded in the blockchain, a user (e.g., a blockchain client application) sends the transaction to one of the nodes of the network to be propagated. Nodes which receive the transaction may race to find a proof-of-work solution incorporating the validated transaction into a new block. Each node is configured to enforce the same node protocol, which will include one or more conditions for a transaction to be valid. Invalid transactions will not be propagated nor incorporated into blocks. Assuming the transaction is validated and thereby accepted onto the blockchain, then the transaction (including any user data) will thus remain registered and indexed at each of the nodes in the blockchain network as an immutable public record.

The node who successfully solved the proof-of-work puzzle to create the latest block is typically rewarded with a new transaction called the “coinbase transaction” which distributes an amount of the digital asset, i.e., a number of tokens. The detection and rejection of invalid transactions is enforced by the actions of competing nodes who act as agents of the network and are incentivised to report and block malfeasance. The widespread publication of information allows users to continuously audit the performance of nodes. The publication of the mere block headers allows participants to ensure the ongoing integrity of the blockchain.

In an “output-based” model (sometimes referred to as a UTXO-based model), the data structure of a given transaction comprises one or more inputs and one or more outputs. Any spendable output comprises an element specifying an amount of the digital asset that is derivable from the proceeding sequence of transactions. The spendable output is sometimes referred to as a UTXO (“unspent transaction output”). The output may further comprise a locking script specifying a condition for the future redemption of the output. A locking script is a predicate defining the conditions necessary to validate and transfer digital tokens or assets. Each input of a transaction (other than a coinbase transaction) comprises a pointer (i.e., a reference) to such an output in a preceding transaction and may further comprise an unlocking script for unlocking the locking script of the pointed-to output. So, consider a pair of transactions, call them a first and a second transaction (or “target” transaction). The first transaction comprises at least one output specifying an amount of the digital asset and comprising a locking script defining one or more conditions of unlocking the output. The second, target transaction comprises at least one input, comprising a pointer to the output of the first transaction, and an unlocking script for unlocking the output of the first transaction.

In such a model, when the second, target transaction is sent to the blockchain network to be propagated and recorded in the blockchain, one of the criteria for validity applied at each node will be that the unlocking script meets all of the one or more conditions defined in the locking script of the first transaction. Another will be that the output of the first transaction has not already been redeemed by another, earlier valid transaction. Any node that finds the target transaction invalid according to any of these conditions will not propagate it (as a valid transaction, but possibly to register an invalid transaction) nor include it in a new block to be recorded in the blockchain.

An alternative type of transaction model is an account-based model. In this case each transaction does not define the amount to be transferred by referring to the UTXO of a preceding transaction in a sequence of past transactions, but rather by reference to an absolute account balance. The current state of all accounts is stored by the nodes separate to the blockchain and is updated constantly.

The term “translucent database” is discussed, for example, in Peter Wayner, Translucent Databases 2^{nd} Edition: “Confusion, Misdirection, Randomness, Sharing, Authentication And Steganography To Defend Privacy” Jan. 8, 2009. A translucent database can be considered to refer to a privacy preserving and secure by design database. A translucent database protects personal data from an insider attack, and in some examples of translucent databases even database administrators and authorised persons are not able to access personal identifiable data. The term “translucent database” is not formally defined. A translucent database is called translucent because it lets some light escape the system while still providing a layer of secrecy. The notion of a translucent database is more goal than a well-defined predicate. A translucent database design is one that minimizes risks to privacy and confidentiality while maintaining usability and functionality. Wayner shows how to build translucent databases using several techniques.

The Linux password file may be considered to comprise a translucent database design, although it predates the coining of the term “translucent database” by Wayner. The Linux password file is discussed in “Practical UNIX and Internet Security, 3^{rd} Edition” by Simon Garfinkel, Gene Spafford, Alan Schwartz, //www.oreilly.com/library/view/practical-unix- and /0596003234/ch04s03.html [accessed on Feb. 9, 2021] and “Understanding/etc/shadow file format in Linux by Vivek Gite” //www.cyberciti.biz/faq/understanding-etcshadow-file/[accessed on 29 Sep. 2021].

In systems prior to the Linux password file, computer systems kept the passwords of the system users in a file in clear text. That was a critical vulnerability since anyone with access rights to the file (or hackers able to circumvent the file access controls) could access all users' passwords. The Linux password file system was designed to address this vulnerability. The system saves the salted hash of the passwords instead of clear text. When a user enters her password, the system calculates the hash of the entered value, and compares it to the hash value it stores, if they match the system grants access. Now, even if the password file is accessed, only salted hashes of the password can be accessed. To obtain the password, the attacker would need to find the pre-image of the stored hash values. This is a trial-and-error process that can take a long time. Note that the system is still required to enforce access rights to the file, however the system is now more secure against insider's attack as well as access rights breaches. The password is saved in the system in the format:
$<id of the hashing algorithm>$<salt>$<hash of the salted password>

First is an id of the hashing algorithm used to create the hash (SHA256, SHA512, etc.), then the salt value that is used, then the hash of the salted password Hash (password|salt).

### SUMMARY

Some techniques that can used to build a translucent database can be considered to be:
1. Encryption and Hashing: For example, using one way hash function and/or encryption to maintain privacy.
2. Ignorance: The data is scrambled by the users/clients rather than the database server. In some examples, the scrambled data may travel over the network such that the translucent database never sees the real information hidden inside.
3. Minimisation: This may comprise storing the base level of information. A minimum amount of data is kept while providing functionality. For example, if a postcode of an address is significant, there is no need to keep an entire address.
4. Misdirection: Using “fake” data to obscure and hide in a manner that does not allow attackers to determine the real information among the fake spurious data. This can be particularly useful when encryption is not enabled.
5. Equivalence: Replacing and obscure sensitive information data with data that is functionally equivalent. For example, instead of an exact height of a person, labels such as “short”, “average” and “tall” may be used. These labels may be determined based on a numerical range in which a value describing a property falls.
6. Quantization: Quantizing values, while providing a higher access level for the precise value. Reducing precision of numbers or values can add privacy and security. For example, latitude and longitude may be recorded in degrees alone while obscuring the minutes and seconds.

A translucent database may have one or more of the above six attributes. It should be noted that a translucent database may not have every possible attribute. Some translucent databases may mix a number of the above attributes.

In examples, a Merkle tree is used when publishing sensitive data to the blockchain. Publishing data to the blockchain provides unmatched evidence that this data is computationally infeasible to have been created (or fabricated) at later time i.e., the publication could not have been created after the bock has been mined.

According to one aspect disclosed herein, there is provided a computer-implemented method comprising obtaining information describing a property. The method also comprises dividing the information into at least two data items describing the property at at least two different levels of precision and obtaining a set of data items for generating a Merkle tree, the set of data items including the at least two data items. The method further comprises generating two or more leaf nodes of a Merkle tree by hashing each data item in the set of data items, wherein the Merkle tree comprises a plurality of leaf nodes including the two or more leaf nodes; and storing at least one of: the Merkle tree; instructions for generating the Merkle tree from the set of data items.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic block diagram of a system for implementing a blockchain,

FIG. 2 schematically illustrates some examples of transactions which may be recorded in a blockchain,

FIG. 3A is a schematic block diagram of a client application,

FIG. 3B is a schematic mock-up of an example user interface that may be presented by the client application of FIG. 3A,

FIG. 4 is a schematic block diagram of some node software for processing transactions,

FIG. 5 is an example diagram of a Merkle tree,

FIG. 6 is an example diagram of a message flow, and

FIG. 7 is an example diagram of a Merkle tree.

### DETAILED DESCRIPTION OF EMBODIMENTS

### Example System Overview

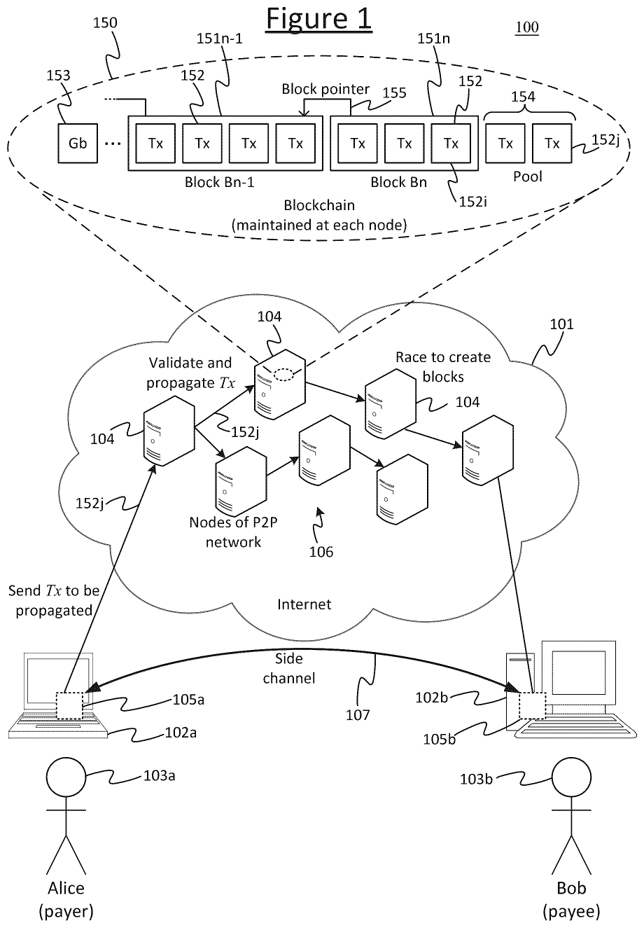

FIG. 1 shows an example system 100 for implementing a blockchain 150. The system 100 may comprise a packet-switched network 101, typically a wide-area internetwork such as the Internet. The packet-switched network 101 comprises a plurality of blockchain nodes 104 that may be arranged to form a peer-to-peer (P2P) network 106 within the packet-switched network 101. Whilst not illustrated, the blockchain nodes 104 may be arranged as a near-complete graph. Each blockchain node 104 is therefore highly connected to other blockchain nodes 104.

Each blockchain node 104 comprises computer equipment of a peer, with different ones of the nodes 104 belonging to different peers. Each blockchain node 104 comprises processing apparatus comprising one or more processors, e.g., one or more central processing units (CPUs), accelerator processors, application specific processors and/or field programmable gate arrays (FPGAs), and other equipment such as application specific integrated circuits (ASICs). Each node also comprises memory, i.e., computer-readable storage in the form of a non-transitory computer-readable medium or media. The memory may comprise one or more memory units employing one or more memory media, e.g., a magnetic medium such as a hard disk; an electronic medium such as a solid-state drive (SSD), flash memory or EEPROM; and/or an optical medium such as an optical disk drive.

The blockchain 150 comprises a chain of blocks of data 151, wherein a respective copy of the blockchain 150 is maintained at each of a plurality of blockchain nodes 104 in the distributed or blockchain network 106. As mentioned above, maintaining a copy of the blockchain 150 does not necessarily mean storing the blockchain 150 in full. Instead, the blockchain 150 may be pruned of data so long as each blockchain node 150 stores the block header (discussed below) of each block 151. Each block 151 in the chain comprises one or more transactions 152, wherein a transaction in this context refers to a kind of data structure. The nature of the data structure will depend on the type of transaction protocol used as part of a transaction model or scheme. A given blockchain will use one particular transaction protocol throughout. In one common type of transaction protocol, the data structure of each transaction 152 comprises at least one input and at least one output. Each output specifies an amount representing a quantity of a digital asset as property, an example of which is a user 103 to whom the output is cryptographically locked (requiring a signature or other solution of that user in order to be unlocked and thereby redeemed or spent). Each input points back to the output of a preceding transaction 152, thereby linking the transactions.

Each block 151 also comprises a block pointer 155 pointing back to the previously created block 151 in the chain so as to define a sequential order to the blocks 151. Each transaction 152 (other than a coinbase transaction) comprises a pointer back to a previous transaction so as to define an order to sequences of transactions (N.B. sequences of transactions 152 are allowed to branch). The chain of blocks 151 goes all the way back to a genesis block (Gb) 153 which was the first block in the chain. One or more original transactions 152 early on in the chain 150 pointed to the genesis block 153 rather than a preceding transaction.

Each of the blockchain nodes 104 is configured to forward transactions 152 to other blockchain nodes 104, and thereby cause transactions 152 to be propagated throughout the network 106. Each blockchain node 104 is configured to create blocks 151 and to store a respective copy of the same blockchain 150 in their respective memory. Each blockchain node 104 also maintains an ordered set (or “pool”) 154 of transactions 152 waiting to be incorporated into blocks 151. The ordered pool 154 is often referred to as a “mempool”. This term herein is not intended to limit to any particular blockchain, protocol or model. It refers to the ordered set of transactions which a node 104 has accepted as valid and for which the node 104 is obliged not to accept any other transactions attempting to spend the same output.

In a given present transaction 152j, the (or each) input comprises a pointer referencing the output of a preceding transaction 152i in the sequence of transactions, specifying that this output is to be redeemed or “spent” in the present transaction 152j. Spending or redeeming does not necessarily imply transfer of a financial asset, though that is certainly one common application. More generally spending could be described as consuming the output, or assigning it to one or more outputs in another, onward transaction. In general, the preceding transaction could be any transaction in the ordered set 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i could equally be called the antecedent or predecessor transaction.

The input of the present transaction 152j also comprises the input authorisation, for example the signature of the user 103a to whom the output of the preceding transaction 152i is locked. In turn, the output of the present transaction 152j can be cryptographically locked to a new user or entity 103b. The present transaction 152j can thus transfer the amount defined in the input of the preceding transaction 152i to the new user or entity 103b as defined in the output of the present transaction 152j. In some cases, a transaction 152 may have multiple outputs to split the input amount between multiple users or entities (one of whom could be the original user or entity 103a in order to give change). In some cases a transaction can also have multiple inputs to gather together the amounts from multiple outputs of one or more preceding transactions, and redistribute to one or more outputs of the current transaction.

According to an output-based transaction protocol such as bitcoin, when a party 103, such as an individual user or an organization, wishes to enact a new transaction 152j (either manually or by an automated process employed by the party), then the enacting party sends the new transaction from its computer terminal 102 to a recipient. The enacting party or the recipient will eventually send this transaction to one or more of the blockchain nodes 104 of the network 106 (which nowadays are typically servers or data centres, but could in principle be other user terminals). It is also not excluded that the party 103 enacting the new transaction 152j could send the transaction directly to one or more of the blockchain nodes 104 and, in some examples, not to the recipient. A blockchain node 104 that receives a transaction checks whether the transaction is valid according to a blockchain node protocol which is applied at each of the blockchain nodes 104. The blockchain node protocol typically requires the blockchain node 104 to check that a cryptographic signature in the new transaction 152j matches the expected signature, which depends on the previous transaction 152i in an ordered sequence of transactions 152. In such an output-based transaction protocol, this may comprise checking that the cryptographic signature or other authorisation of the party 103 included in the input of the new transaction 152j matches a condition defined in the output of the preceding transaction 152i which the new transaction spends (or “assigns”), wherein this condition typically comprises at least checking that the cryptographic signature or other authorisation in the input of the new transaction 152j unlocks the output of the previous transaction 152i to which the input of the new transaction is linked to. The condition may be at least partially defined by a script included in the output of the preceding transaction 152i. Alternatively it could simply be fixed by the blockchain node protocol alone, or it could be due to a combination of these. Either way, if the new transaction 152j is valid, the blockchain node 104 forwards it to one or more other blockchain nodes 104 in the blockchain network 106. These other blockchain nodes 104 apply the same test according to the same blockchain node protocol, and so forward the new transaction 152j on to one or more further nodes 104, and so forth. In this way the new transaction is propagated throughout the network of blockchain nodes 104.

In an output-based model, the definition of whether a given output (e.g. UTXO) is assigned (or “spent”) is whether it has yet been validly redeemed by the input of another, onward transaction 152j according to the blockchain node protocol. Another condition for a transaction to be valid is that the output of the preceding transaction 152i which it attempts to redeem has not already been redeemed by another transaction. Again if not valid, the transaction 152j will not be propagated (unless flagged as invalid and propagated for alerting) or recorded in the blockchain 150. This guards against double-spending whereby the transactor tries to assign the output of the same transaction more than once. An account-based model on the other hand guards against double-spending by maintaining an account balance. Because again there is a defined order of transactions, the account balance has a single defined state at any one time.

In addition to validating transactions, blockchain nodes 104 also race to be the first to create blocks of transactions in a process commonly referred to as mining, which is supported by “proof-of-work”. At a blockchain node 104, new transactions are added to an ordered pool 154 of valid transactions that have not yet appeared in a block 151 recorded on the blockchain 150. The blockchain nodes then race to assemble a new valid block 151 of transactions 152 from the ordered set of transactions 154 by attempting to solve a cryptographic puzzle. Typically this comprises searching for a “nonce” value such that when the nonce is concatenated with a representation of the ordered pool of pending transactions 154 and hashed, then the output of the hash meets a predetermined condition. E.g. the predetermined condition may be that the output of the hash has a certain predefined number of leading zeros. Note that this is just one particular type of proof-of-work puzzle, and other types are not excluded. A property of a hash function is that it has an unpredictable output with respect to its input. Therefore this search can only be performed by brute force, thus consuming a substantive amount of processing resource at each blockchain node 104 that is trying to solve the puzzle.

The first blockchain node 104 to solve the puzzle announces this to the network 106, providing the solution as proof which can then be easily checked by the other blockchain nodes 104 in the network (once given the solution to a hash it is straightforward to check that it causes the output of the hash to meet the condition). The first blockchain node 104 propagates a block to a threshold consensus of other nodes that accept the block and thus enforce the protocol rules. The ordered set of transactions 154 then becomes recorded as a new block 151 in the blockchain 150 by each of the blockchain nodes 104. A block pointer 155 is also assigned to the new block 151n pointing back to the previously created block 151n-1 in the chain. The significant amount of effort, for example in the form of hash, required to create a proof-of-work solution signals the intent of the first node 104 to follow the rules of the blockchain protocol. Such rules include not accepting a transaction as valid if it spends or assigns the same output as a previously validated transaction, otherwise known as double-spending. Once created, the block 151 cannot be modified since it is recognized and maintained at each of the blockchain nodes 104 in the blockchain network 106. The block pointer 155 also imposes a sequential order to the blocks 151. Since the transactions 152 are recorded in the ordered blocks at each blockchain node 104 in a network 106, this therefore provides an immutable public ledger of the transactions.

Note that different blockchain nodes 104 racing to solve the puzzle at any given time may be doing so based on different snapshots of the pool of yet-to-be published transactions 154 at any given time, depending on when they started searching for a solution or the order in which the transactions were received. Whoever solves their respective puzzle first defines which transactions 152 are included in the next new block 151n and in which order, and the current pool 154 of unpublished transactions is updated. The blockchain nodes 104 then continue to race to create a block from the newly-defined ordered pool of unpublished transactions 154, and so forth. A protocol also exists for resolving any “fork” that may arise, which is where two blockchain nodes 104 solve their puzzle within a very short time of one another such that a conflicting view of the blockchain gets propagated between nodes 104. In short, whichever prong of the fork grows the longest becomes the definitive blockchain 150. Note this should not affect the users or agents of the network as the same transactions will appear in both forks.

According to the bitcoin blockchain (and most other blockchains) a node that successfully constructs a new block 104 is granted the ability to newly assign an additional, accepted amount of the digital asset in a new special kind of transaction which distributes an additional defined quantity of the digital asset (as opposed to an inter-agent, or inter-user transaction which transfers an amount of the digital asset from one agent or user to another). This special type of transaction is usually referred to as a “coinbase transaction”, but may also be termed an “initiation transaction” or “generation transaction”. It typically forms the first transaction of the new block 151n. The proof-of-work signals the intent of the node that constructs the new block to follow the protocol rules allowing this special transaction to be redeemed later. The blockchain protocol rules may require a maturity period, for example 100 blocks, before this special transaction may be redeemed. Often a regular (non-generation) transaction 152 will also specify an additional transaction fee in one of its outputs, to further reward the blockchain node 104 that created the block 151n in which that transaction was published. This fee is normally referred to as the “transaction fee”, and is discussed blow.

Due to the resources involved in transaction validation and publication, typically at least each of the blockchain nodes 104 takes the form of a server comprising one or more physical server units, or even whole a data centre. However in principle any given blockchain node 104 could take the form of a user terminal or a group of user terminals networked together.

The memory of each blockchain node 104 stores software configured to run on the processing apparatus of the blockchain node 104 in order to perform its respective role or roles and handle transactions 152 in accordance with the blockchain node protocol. It will be understood that any action attributed herein to a blockchain node 104 may be performed by the software run on the processing apparatus of the respective computer equipment. The node software may be implemented in one or more applications at the application layer, or a lower layer such as the operating system layer or a protocol layer, or any combination of these.

Also connected to the network 101 is the computer equipment 102 of each of a plurality of parties 103 in the role of consuming users. These users may interact with the blockchain network 106 but do not participate in validating transactions or constructing blocks. Some of these users or agents 103 may act as senders and recipients in transactions. Other users may interact with the blockchain 150 without necessarily acting as senders or recipients. For instance, some parties may act as storage entities that store a copy of the blockchain 150 (e.g. having obtained a copy of the blockchain from a blockchain node 104).

Some or all of the parties 103 may be connected as part of a different network, e.g. a network overlaid on top of the blockchain network 106. Users of the blockchain network (often referred to as “clients”) may be said to be part of a system that includes the blockchain network 106; however, these users are not blockchain nodes 104 as they do not perform the roles required of the blockchain nodes. Instead, each party 103 may interact with the blockchain network 106 and thereby utilize the blockchain 150 by connecting to (i.e. communicating with) a blockchain node 106. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system 100, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second “party” respectively.

The computer equipment 102 of each party 103 comprises respective processing apparatus comprising one or more processors, e.g. one or more CPUs, GPUs, other accelerator processors, application specific processors, and/or FPGAs. The computer equipment 102 of each party 103 further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment 102 of each party 103 stores software comprising a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 comprises at least one user terminal, e.g. a desktop or laptop computer, a tablet, a smartphone, or a wearable device such as a smartwatch. The computer equipment 102 of a given party 103 may also comprise one or more other networked resources, such as cloud computing resources accessed via the user terminal.

The client application 105 may be initially provided to the computer equipment 102 of any given party 103 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 comprises at least a “wallet” function. This has two main functionalities. One of these is to enable the respective party 103 to create, authorize (for example sign) and send transactions 152 to one or more bitcoin nodes 104 to then be propagated throughout the network of blockchain nodes 104 and thereby included in the blockchain 150. The other is to report back to the respective party the amount of the digital asset that he or she currently owns. In an output-based system, this second functionality comprises collating the amounts defined in the outputs of the various 152 transactions scattered throughout the blockchain 150 that belong to the party in question.

Note: whilst the various client functionality may be described as being integrated into a given client application 105, this is not necessarily limiting and instead any client functionality described herein may instead be implemented in a suite of two or more distinct applications, e.g. interfacing via an API, or one being a plug-in to the other. More generally the client functionality could be implemented at the application layer or a lower layer such as the operating system, or any combination of these. The following will be described in terms of a client application 105 but it will be appreciated that this is not limiting.

The instance of the client application or software 105 on each computer equipment 102 is operatively coupled to at least one of the blockchain nodes 104 of the network 106. This enables the wallet function of the client 105 to send transactions 152 to the network 106. The client 105 is also able to contact blockchain nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility). The wallet function on each computer equipment 102 is configured to formulate and send transactions 152 according to a transaction protocol. As set out above, each blockchain node 104 runs software configured to validate transactions 152 according to the blockchain node protocol, and to forward transactions 152 in order to propagate them throughout the blockchain network 106. The transaction protocol and the node protocol correspond to one another, and a given transaction protocol goes with a given node protocol, together implementing a given transaction model. The same transaction protocol is used for all transactions 152 in the blockchain 150. The same node protocol is used by all the nodes 104 in the network 106.

When a given party 103, say Alice, wishes to send a new transaction 152j to be included in the blockchain 150, then she formulates the new transaction in accordance with the relevant transaction protocol (using the wallet function in her client application 105). She then sends the transaction 152 from the client application 105 to one or more blockchain nodes 104 to which she is connected. E.g. this could be the blockchain node 104 that is best connected to Alice's computer 102. When any given blockchain node 104 receives a new transaction 152j, it handles it in accordance with the blockchain node protocol and its respective role. This comprises first checking whether the newly received transaction 152j meets a certain condition for being “valid”, examples of which will be discussed in more detail shortly. In some transaction protocols, the condition for validation may be configurable on a per-transaction basis by scripts included in the transactions 152. Alternatively the condition could simply be a built-in feature of the node protocol, or be defined by a combination of the script and the node protocol.

On condition that the newly received transaction 152j passes the test for being deemed valid (i.e. on condition that it is “validated”), any blockchain node 104 that receives the transaction 152j will add the new validated transaction 152 to the ordered set of transactions 154 maintained at that blockchain node 104. Further, any blockchain node 104 that receives the transaction 152j will propagate the validated transaction 152 onward to one or more other blockchain nodes 104 in the network 106. Since each blockchain node 104 applies the same protocol, then assuming the transaction 152j is valid, this means it will soon be propagated throughout the whole network 106.

Once admitted to the ordered pool of pending transactions 154 maintained at a given blockchain node 104, that blockchain node 104 will start competing to solve the proof-of-work puzzle on the latest version of their respective pool of 154 including the new transaction 152 (recall that other blockchain nodes 104 may be trying to solve the puzzle based on a different pool of transactions 154, but whoever gets there first will define the set of transactions that are included in the latest block 151. Eventually a blockchain node 104 will solve the puzzle for a part of the ordered pool 154 which includes Alice's transaction 152j). Once the proof-of-work has been done for the pool 154 including the new transaction 152j, it immutably becomes part of one of the blocks 151 in the blockchain 150. Each transaction 152 comprises a pointer back to an earlier transaction, so the order of the transactions is also immutably recorded.

Different blockchain nodes 104 may receive different instances of a given transaction first and therefore have conflicting views of which instance is ‘valid’ before one instance is published in a new block 151, at which point all blockchain nodes 104 agree that the published instance is the only valid instance. If a blockchain node 104 accepts one instance as valid, and then discovers that a second instance has been recorded in the blockchain 150 then that blockchain node 104 must accept this and will discard (i.e. treat as invalid) the instance which it had initially accepted (i.e. the one that has not been published in a block 151).

An alternative type of transaction protocol operated by some blockchain networks may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored, by the nodes of that network, separate to the blockchain and is updated constantly. In such a system, transactions are ordered using a running transaction tally of the account (also called the “position”). This value is signed by the sender as part of their cryptographic signature and is hashed as part of the transaction reference calculation. In addition, an optional data field may also be signed the transaction. This data field may point back to a previous transaction, for example if the previous transaction ID is included in the data field.

### UTXO-Based Model

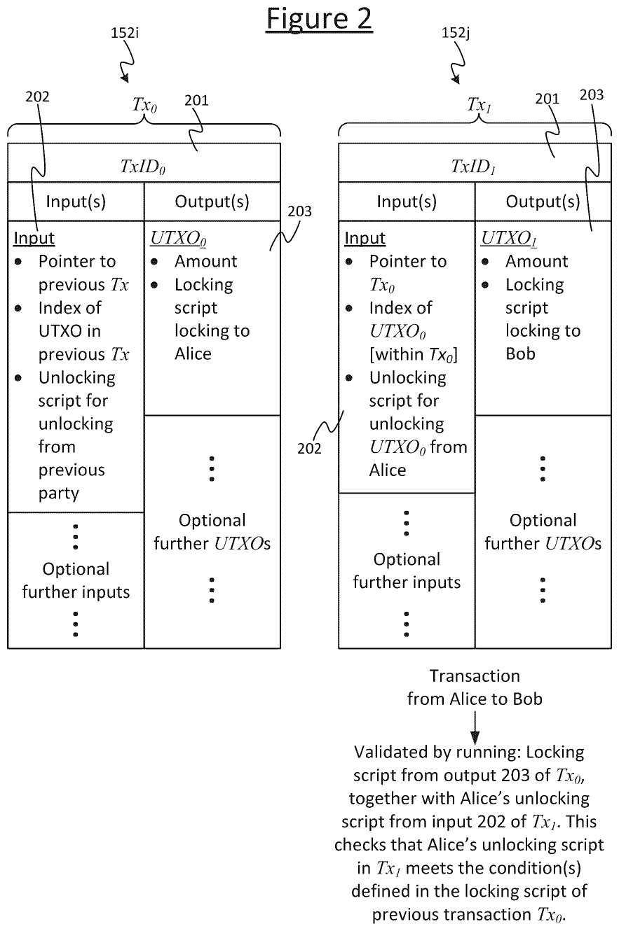

FIG. 2 illustrates an example transaction protocol. This is an example of a UTXO-based protocol. A transaction 152 (abbreviated “Tx”) is the fundamental data structure of the blockchain 150 (each block 151 comprising one or more transactions 152). The following will be described by reference to an output-based or “UTXO” based protocol. However, this is not limiting to all possible embodiments. Note that while the example UTXO-based protocol is described with reference to bitcoin, it may equally be implemented on other example blockchain networks.

In a UTXO-based model, each transaction (“Tx”) 152 comprises a data structure comprising one or more inputs 202, and one or more outputs 203. Each output 203 may comprise an unspent transaction output (UTXO), which can be used as the source for the input 202 of another new transaction (if the UTXO has not already been redeemed). The UTXO includes a value specifying an amount of a digital asset. This represents a set number of tokens on the distributed ledger. The UTXO may also contain the transaction ID of the transaction from which it came, amongst other information. The transaction data structure may also comprise a header 201, which may comprise an indicator of the size of the input field(s) 202 and output field(s) 203. The header 201 may also include an ID of the transaction. In embodiments the transaction ID is the hash of the transaction data (excluding the transaction ID itself) and stored in the header 201 of the raw transaction 152 submitted to the nodes 104.

Say Alice 103a wishes to create a transaction 152j transferring an amount of the digital asset in question to Bob 103b. In FIG. 2 Alice's new transaction 152j is labelled “Tx₁”. It takes an amount of the digital asset that is locked to Alice in the output 203 of a preceding transaction 152i in the sequence, and transfers at least some of this to Bob. The preceding transaction 152i is labelled “Tx₀” in FIG. 2. Tx₀ and Tx₁ are just arbitrary labels. They do not necessarily mean that Tx₀ is the first transaction in the blockchain 151, nor that Tx₁ is the immediate next transaction in the pool 154. Tx₁ could point back to any preceding (i.e. antecedent) transaction that still has an unspent output 203 locked to Alice.

The preceding transaction Tx₀ may already have been validated and included in a block 151 of the blockchain 150 at the time when Alice creates her new transaction Tx₁, or at least by the time she sends it to the network 106. It may already have been included in one of the blocks 151 at that time, or it may be still waiting in the ordered set 154 in which case it will soon be included in a new block 151. Alternatively Tx₀ and Tx₁ could be created and sent to the network 106 together, or Tx₀ could even be sent after Tx₁ if the node protocol allows for buffering “orphan” transactions. The terms “preceding” and “subsequent” as used herein in the context of the sequence of transactions refer to the order of the transactions in the sequence as defined by the transaction pointers specified in the transactions (which transaction points back to which other transaction, and so forth). They could equally be replaced with “predecessor” and “successor”, or “antecedent” and “descendant”, “parent” and “child”, or such like. It does not necessarily imply an order in which they are created, sent to the network 106, or arrive at any given blockchain node 104. Nevertheless, a subsequent transaction (the descendent transaction or “child”) which points to a preceding transaction (the antecedent transaction or “parent”) will not be validated until and unless the parent transaction is validated. A child that arrives at a blockchain node 104 before its parent is considered an orphan. It may be discarded or buffered for a certain time to wait for the parent, depending on the node protocol and/or node behaviour.

One of the one or more outputs 203 of the preceding transaction Tx₀ comprises a particular UTXO, labelled here UTXO₀. Each UTXO comprises a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed. Typically the locking script locks the amount to a particular party (the beneficiary of the transaction in which it is included). I.e. the locking script defines an unlocking condition, typically comprising a condition that the unlocking script in the input of the subsequent transaction comprises the cryptographic signature of the party to whom the preceding transaction is locked.

The locking script (aka scriptPubKey) is a piece of code written in the domain specific language recognized by the node protocol. A particular example of such a language is called “Script” (capital S) which is used by the blockchain network. The locking script specifies what information is required to spend a transaction output 203, for example the requirement of Alice's signature. Unlocking scripts appear in the outputs of transactions. The unlocking script (aka scriptSig) is a piece of code written the domain specific language that provides the information required to satisfy the locking script criteria. For example, it may contain Bob's signature. Unlocking scripts appear in the input 202 of transactions.

So in the example illustrated, UTXO₀ in the output 203 of Tx₀ comprises a locking script [Checksig P_{A}] which requires a signature Sig P_{A} of Alice in order for UTXO₀ to be redeemed (strictly, in order for a subsequent transaction attempting to redeem UTXO₀ to be valid). [Checksig P_{A}] contains a representation (i.e. a hash) of the public key P_{A} from a public-private key pair of Alice. The input 202 of Tx₁ comprises a pointer pointing back to Tx₁ (e.g. by means of its transaction ID, TxID₀, which in embodiments is the hash of the whole transaction Tx₀). The input 202 of Tx₁ comprises an index identifying UTXO₀ within Tx₀, to identify it amongst any other possible outputs of Tx₀. The input 202 of Tx₁ further comprises an unlocking script <Sig P_{A}> which comprises a cryptographic signature of Alice, created by Alice applying her private key from the key pair to a predefined portion of data (sometimes called the “message” in cryptography). The data (or “message”) that needs to be signed by Alice to provide a valid signature may be defined by the locking script, or by the node protocol, or by a combination of these.

When the new transaction Tx₁ arrives at a blockchain node 104, the node applies the node protocol. This comprises running the locking script and unlocking script together to check whether the unlocking script meets the condition defined in the locking script (where this condition may comprise one or more criteria). In embodiments this involves concatenating the two scripts:
<Sig P_{A}> <P_{A}>∥[Checksig P_{A}]
where “∥” represents a concatenation and “< . . . >” means place the data on the stack, and “[ . . . ]” is a function comprised by the locking script (in this example a stack-based language). Equivalently the scripts may be run one after the other, with a common stack, rather than concatenating the scripts. Either way, when run together, the scripts use the public key P_{A} of Alice, as included in the locking script in the output of Tx₀, to authenticate that the unlocking script in the input of Tx₁ contains the signature of Alice signing the expected portion of data. The expected portion of data itself (the “message”) also needs to be included in order to perform this authentication. In embodiments the signed data comprises the whole of Tx₁ (so a separate element does not need to be included specifying the signed portion of data in the clear, as it is already inherently present).

The details of authentication by public-private cryptography will be familiar to a person skilled in the art. Basically, if Alice has signed a message using her private key, then given Alice's public key and the message in the clear, another entity such as a node 104 is able to authenticate that the message must have been signed by Alice. Signing typically comprises hashing the message, signing the hash, and tagging this onto the message as a signature, thus enabling any holder of the public key to authenticate the signature. Note therefore that any reference herein to signing a particular piece of data or part of a transaction, or such like, can in embodiments mean signing a hash of that piece of data or part of the transaction.

If the unlocking script in Tx₁ meets the one or more conditions specified in the locking script of Tx₀ (so in the example shown, if Alice's signature is provided in Tx₁ and authenticated), then the blockchain node 104 deems Tx₁ valid. This means that the blockchain node 104 will add Tx₁ to the ordered pool of pending transactions 154. The blockchain node 104 will also forward the transaction Tx₁ to one or more other blockchain nodes 104 in the network 106, so that it will be propagated throughout the network 106. Once Tx₁ has been validated and included in the blockchain 150, this defines UTXO₀ from Tx₀ as spent. Note that Tx₁ can only be valid if it spends an unspent transaction output 203. If it attempts to spend an output that has already been spent by another transaction 152, then Tx₁ will be invalid even if all the other conditions are met. Hence the blockchain node 104 also needs to check whether the referenced UTXO in the preceding transaction Tx₀ is already spent (i.e. whether it has already formed a valid input to another valid transaction). This is one reason why it is important for the blockchain 150 to impose a defined order on the transactions 152. In practice a given blockchain node 104 may maintain a separate database marking which UTXOs 203 in which transactions 152 have been spent, but ultimately what defines whether a UTXO has been spent is whether it has already formed a valid input to another valid transaction in the blockchain 150.

If the total amount specified in all the outputs 203 of a given transaction 152 is greater than the total amount pointed to by all its inputs 202, this is another basis for invalidity in most transaction models. Therefore such transactions will not be propagated nor included in a block 151.

Note that in UTXO-based transaction models, a given UTXO needs to be spent as a whole. It cannot “leave behind” a fraction of the amount defined in the UTXO as spent while another fraction is spent. However the amount from the UTXO can be split between multiple outputs of the next transaction. E.g. the amount defined in UTXO₀ in Tx₀ can be split between multiple UTXOs in Tx₁. Hence if Alice does not want to give Bob all of the amount defined in UTXO₀, she can use the remainder to give herself change in a second output of Tx₁, or pay another party.

In practice Alice will also usually need to include a fee for the bitcoin node 104 that successfully includes her transaction 104 in a block 151. If Alice does not include such a fee, Tx₀ may be rejected by the blockchain nodes 104, and hence although technically valid, may not be propagated and included in the blockchain 150 (the node protocol does not force blockchain nodes 104 to accept transactions 152 if they don't want). In some protocols, the transaction fee does not require its own separate output 203 (i.e. does not need a separate UTXO). Instead any difference between the total amount pointed to by the input(s) 202 and the total amount of specified in the output(s) 203 of a given transaction 152 is automatically given to the blockchain node 104 publishing the transaction. E.g. say a pointer to UTXO₀ is the only input to Tx₁, and Tx₁ has only one output UTXO₁. If the amount of the digital asset specified in UTXO₀ is greater than the amount specified in UTXO₁, then the difference may be assigned (or spent) by the node 104 that wins the proof-of-work race to create the block containing UTXO₁. Alternatively or additionally however, it is not necessarily excluded that a transaction fee could be specified explicitly in its own one of the UTXOs 203 of the transaction 152.

Alice and Bob's digital assets consist of the UTXOs locked to them in any transactions 152 anywhere in the blockchain 150. Hence typically, the assets of a given party 103 are scattered throughout the UTXOs of various transactions 152 throughout the blockchain 150. There is no one number stored anywhere in the blockchain 150 that defines the total balance of a given party 103. It is the role of the wallet function in the client application 105 to collate together the values of all the various UTXOs which are locked to the respective party and have not yet been spent in another onward transaction. It can do this by querying the copy of the blockchain 150 as stored at any of the bitcoin nodes 104.

Note that the script code is often represented schematically (i.e. not using the exact language). For example, one may use operation codes (opcodes) to represent a particular function. “OP_” refers to a particular opcode of the Script language. As an example, OP_RETURN is an opcode of the Script language that when preceded by OP_FALSE at the beginning of a locking script creates an unspendable output of a transaction that can store data within the transaction, and thereby record the data immutably in the blockchain 150. E.g. the data could comprise a document which it is desired to store in the blockchain.

Typically an input of a transaction contains a digital signature corresponding to a public key P_{A}. In embodiments this is based on the ECDSA using the elliptic curve secp256k1. A digital signature signs a particular piece of data. In some embodiments, for a given transaction the signature will sign part of the transaction input, and some or all of the transaction outputs. The particular parts of the outputs it signs depends on the SIGHASH flag. The SIGHASH flag is usually a 4-byte code included at the end of a signature to select which outputs are signed (and thus fixed at the time of signing).

The locking script is sometimes called “scriptPubKey” referring to the fact that it typically comprises the public key of the party to whom the respective transaction is locked. The unlocking script is sometimes called “scriptSig” referring to the fact that it typically supplies the corresponding signature. However, more generally it is not essential in all applications of a blockchain 150 that the condition for a UTXO to be redeemed comprises authenticating a signature. More generally the scripting language could be used to define any one or more conditions. Hence the more general terms “locking script” and “unlocking script” may be preferred.

### Side Channel

As shown in FIG. 1, the client application on each of Alice and Bob's computer equipment 102a, 120b, respectively, may comprise additional communication functionality. This additional functionality enables Alice 103a to establish a separate side channel 107 with Bob 103b (at the instigation of either party or a third party). The side channel 107 enables exchange of data separately from the blockchain network. Such communication is sometimes referred to as “off-chain” communication. For instance this may be used to exchange a transaction 152 between Alice and Bob without the transaction (yet) being registered onto the blockchain network 106 or making its way onto the chain 150, until one of the parties chooses to broadcast it to the network 106. Sharing a transaction in this way is sometimes referred to as sharing a “transaction template”. A transaction template may lack one or more inputs and/or outputs that are required in order to form a complete transaction. Alternatively or additionally, the side channel 107 may be used to exchange any other transaction related data, such as keys, negotiated amounts or terms, data content, etc.

The side channel 107 may be established via the same packet-switched network 101 as the blockchain network 106. Alternatively or additionally, the side channel 301 may be established via a different network such as a mobile cellular network, or a local area network such as a local wireless network, or even a direct wired or wireless link between Alice and Bob's devices 102a, 102b. Generally, the side channel 107 as referred to anywhere herein may comprise any one or more links via one or more networking technologies or communication media for exchanging data “off-chain”, i.e. separately from the blockchain network 106. Where more than one link is used, then the bundle or collection of off-chain links as a whole may be referred to as the side channel 107. Note therefore that if it is said that Alice and Bob exchange certain pieces of information or data, or such like, over the side channel 107, then this does not necessarily imply all these pieces of data have to be send over exactly the same link or even the same type of network.

### Client Software

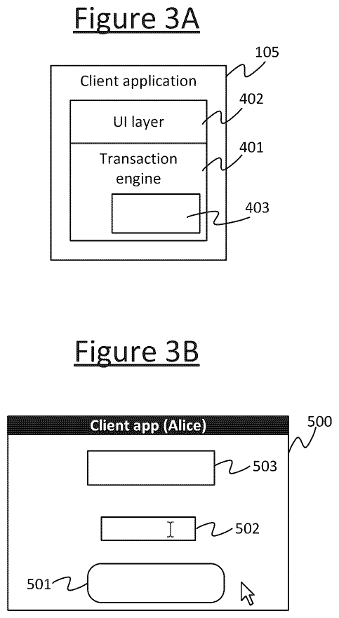

FIG. 3A illustrates an example implementation of the client application 105 for implementing embodiments of the presently disclosed scheme. The client application 105 comprises a transaction engine 401 and a user interface (UI) layer 402. The transaction engine 401 is configured to implement the underlying transaction-related functionality of the client 105, such as to formulate transactions 152, receive and/or send transactions and/or other data over the side channel 301, and/or send transactions to one or more nodes 104 to be propagated through the blockchain network 106, in accordance with the schemes discussed above and as discussed in further detail shortly.

The UI layer 402 is configured to render a user interface via a user input/output (I/O) means of the respective user's computer equipment 102, including outputting information to the respective user 103 via a user output means of the equipment 102, and receiving inputs back from the respective user 103 via a user input means of the equipment 102. For example the user output means could comprise one or more display screens (touch or non-touch screen) for providing a visual output, one or more speakers for providing an audio output, and/or one or more haptic output devices for providing a tactile output, etc. The user input means could comprise for example the input array of one or more touch screens (the same or different as that/those used for the output means); one or more cursor-based devices such as mouse, trackpad or trackball; one or more microphones and speech or voice recognition algorithms for receiving a speech or vocal input; one or more gesture-based input devices for receiving the input in the form of manual or bodily gestures; or one or more mechanical buttons, switches or joysticks, etc.

Note: whilst the various functionality herein may be described as being integrated into the same client application 105, this is not necessarily limiting and instead they could be implemented in a suite of two or more distinct applications, e.g. one being a plug-in to the other or interfacing via an API (application programming interface). For instance, the functionality of the transaction engine 401 may be implemented in a separate application than the UI layer 402, or the functionality of a given module such as the transaction engine 401 could be split between more than one application. Nor is it excluded that some or all of the described functionality could be implemented at, say, the operating system layer. Where reference is made anywhere herein to a single or given application 105, or such like, it will be appreciated that this is just by way of example, and more generally the described functionality could be implemented in any form of software.

FIG. 3B gives a mock-up of an example of the user interface (UI) 500 which may be rendered by the UI layer 402 of the client application 105a on Alice's equipment 102a. It will be appreciated that a similar UI may be rendered by the client 105b on Bob's equipment 102b, or that of any other party.

By way of illustration FIG. 3B shows the UI 500 from Alice's perspective. The UI 500 may comprise one or more UI elements 501, 502, 502 rendered as distinct UI elements via the user output means.

For example, the UI elements may comprise one or more user-selectable elements 501 which may be, such as different on-screen buttons, or different options in a menu, or such like. The user input means is arranged to enable the user 103 (in this case Alice 103a) to select or otherwise operate one of the options, such as by clicking or touching the UI element on-screen, or speaking a name of the desired option (N.B. the term “manual” as used herein is meant only to contrast against automatic, and does not necessarily limit to the use of the hand or hands).

Alternatively or additionally, the UI elements may comprise one or more data entry fields 502. These data entry fields are rendered via the user output means, e.g. on-screen, and the data can be entered into the fields through the user input means, e.g. a keyboard or touchscreen. Alternatively the data could be received orally for example based on speech recognition.

Alternatively or additionally, the UI elements may comprise one or more information elements 503 output to output information to the user. E.g. this/these could be rendered on screen or audibly.

It will be appreciated that the particular means of rendering the various UI elements, selecting the options and entering data is not material. The functionality of these UI elements will be discussed in more detail shortly. It will also be appreciated that the UI 500 shown in FIG. 3 is only a schematized mock-up and in practice it may comprise one or more further UI elements, which for conciseness are not illustrated.

### Node Software

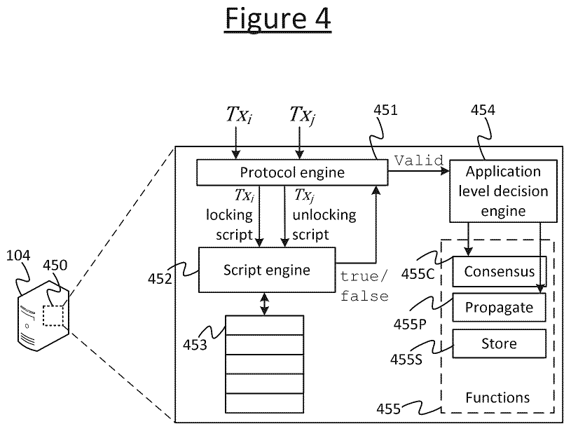

FIG. 4 illustrates an example of the node software 450 that is run on each blockchain node 104 of the network 106, in the example of a UTXO- or output-based model. Note that another entity may run node software 450 without being classed as a node 104 on the network 106, i.e. without performing the actions required of a node 104. The node software 450 may contain, but is not limited to, a protocol engine 451, a script engine 452, a stack 453, an application-level decision engine 454, and a set of one or more blockchain-related functional modules 455. Each node 104 may run node software that contains, but is not limited to, all three of: a consensus module 455C (for example, proof-of-work), a propagation module 455P and a storage module 455S (for example, a database). The protocol engine 401 is typically configured to recognize the different fields of a transaction 152 and process them in accordance with the node protocol. When a transaction 152j (Txⱼ) is received having an input pointing to an output (e.g. UTXO) of another, preceding transaction 152i (Txₘ₋₁), then the protocol engine 451 identifies the unlocking script in Tx and passes it to the script engine 452. The protocol engine 451 also identifies and retrieves Txᵢ based on the pointer in the input of Txⱼ. Txᵢ may be published on the blockchain 150, in which case the protocol engine may retrieve Txᵢ from a copy of a block 151 of the blockchain 150 stored at the node 104. Alternatively, Txᵢ may yet to have been published on the blockchain 150. In that case, the protocol engine 451 may retrieve Txᵢ from the ordered set 154 of unpublished transactions maintained by the node 104. Either way, the script engine 451 identifies the locking script in the referenced output of Txᵢ and passes this to the script engine 452.

The script engine 452 thus has the locking script of Txᵢ and the unlocking script from the corresponding input of Txⱼ. For example, transactions labelled Tx₀ and Tx₁ are illustrated in FIG. 2, but the same could apply for any pair of transactions. The script engine 452 runs the two scripts together as discussed previously, which will include placing data onto and retrieving data from the stack 453 in accordance with the stack-based scripting language being used (e.g. Script).

By running the scripts together, the script engine 452 determines whether or not the unlocking script meets the one or more criteria defined in the locking script—i.e. does it “unlock” the output in which the locking script is included? The script engine 452 returns a result of this determination to the protocol engine 451. If the script engine 452 determines that the unlocking script does meet the one or more criteria specified in the corresponding locking script, then it returns the result “true”. Otherwise it returns the result “false”.

In an output-based model, the result “true” from the script engine 452 is one of the conditions for validity of the transaction. Typically there are also one or more further, protocol-level conditions evaluated by the protocol engine 451 that must be met as well; such as that the total amount of digital asset specified in the output(s) of Txⱼ does not exceed the total amount pointed to by its inputs, and that the pointed-to output of Txᵢ has not already been spent by another valid transaction. The protocol engine 451 evaluates the result from the script engine 452 together with the one or more protocol-level conditions, and only if they are all true does it validate the transaction Txⱼ. The protocol engine 451 outputs an indication of whether the transaction is valid to the application-level decision engine 454. Only on condition that Txⱼ is indeed validated, the decision engine 454 may select to control both of the consensus module 455C and the propagation module 455P to perform their respective blockchain-related function in respect of Txⱼ. This comprises the consensus module 455C adding Txⱼ to the node's respective ordered set of transactions 154 for incorporating in a block 151, and the propagation module 455P forwarding Txⱼ to another blockchain node 104 in the network 106. Optionally, in embodiments the application-level decision engine 454 may apply one or more additional conditions before triggering either or both of these functions. E.g. the decision engine may only select to publish the transaction on condition that the transaction is both valid and leaves enough of a transaction fee.

Note also that the terms “true” and “false” herein do not necessarily limit to returning a result represented in the form of only a single binary digit (bit), though that is certainly one possible implementation. More generally, “true” can refer to any state indicative of a successful or affirmative outcome, and “false” can refer to any state indicative of an unsuccessful or non-affirmative outcome. For instance in an account-based model, a result of “true” could be indicated by a combination of an implicit, protocol-level validation of a signature and an additional affirmative output of a smart contract (the overall result being deemed to signal true if both individual outcomes are true).

### Translucent Blockchain Database

In some examples, a translucent database may be considered to comprise a “neutral switch” of data. A translucent database in some examples may be used to move information without seeing crucial bits. Intelligent clients on the edge of the network may perform the encryption, scrambling much of the information before it leaves the client. This is discussed in Peter Wayner, Translucent Databases 2^{nd} Edition: “Confusion, Misdirection, Randomness, Sharing, Authentication And Steganography To Defend Privacy” Jan. 8, 2009, which further states that advantages of translucent databases can be “security (especially against insiders threat), operating systems independence, privacy, freedom from requests, simplicity, mixed access (different levels of access), speed, distributed workloads (encryption can be done by clients and the server does not need even to decrypt it). These advantages are not guaranteed for every use case”.

Examples use case scenarios of translucent databases given in Peter Wayner, Translucent Databases 2^{nd} Edition: “Confusion, Misdirection, Randomness, Sharing, Authentication And Steganography To Defend Privacy” Jan. 8, 2009 include:
A database that hides the position of Navy ships from enemies while simultaneously providing accurate information to those with proper authorization.
An anti-rape database that identifies trends without containing any personal information.
A babysitter scheduling service that matches parents with available sitters while protecting the sitters' identities and locations.
A department store database that guards the modesty of customers.
A private accounting system that detects fraud without revealing information.
A poker game for the Internet that prevents cheating.
A pharmacy database for preventing dangerous drug interactions while keeping medical records secure.
A tool for travel agents to protect their clients from stalkers and kidnappers.
A stock exchange transaction mechanism designed to stop insider-trading.
A website logfile tool that provides accurate counts of visitors while protecting their identities.
A credit-card database for defending crucial e-commerce transactions.
A patent search tool that doesn't reveal the nature and focus of the search.
A conference bulletin board that routes messages without helping stalkers.
A tool for studying the radon concentration in homes without maintaining personal information.
An anti-money laundering database.
Privacy-preserving car tracking.
XML encoding and decoding.
Fuzzy and incomplete matching.

The method described herein could be applied to any of the above possible use cases. When providing a translucent database system, privacy measures that render the system unusable would result in dropping these measures altogether or replacing the system with a usable albeit insecure alternative. Examples described herein provide a useable translucent database system. Translucent database design assumes that access control policies are enforced, however, even if these policies are compromised, sensitive data are still protected since they are stored as ciphertext or hash values.

In examples, a Merkle tree is used when publishing sensitive data to the blockchain. Publishing data to the blockchain provides unmatched evidence that this data is computationally infeasible to have been created (or fabricated) at later time i.e., the publication could not have been created after the bock has been mined.

In some examples, data (information) is divided into data fields (data items). Each data field is then hashed separately, and the hashes are mapped to the leaves of a Merkle tree. A root value of the tree can also be calculated. The root value may be inserted as a value inserted in the transaction. This provides confidentiality for all data fields. At the same time, selective disclosure to individual data field and linking them to the root is possible without having to disclose the entire data. In some examples, one or more of the above six attributes of translucent databases are achieved by using Merkle trees.

In some examples, translucent database techniques are applied when publishing invoice data to the blockchain. While publishing invoice data on public ledger, it may be desired to protect the shopper's privacy even from the prying eyes of insiders, which is where translucent database techniques can help.

In some examples, invoice data is divided into fields (data items), where each field is hashed separately, and these hashes are used to construct a Merkle tree. The Merkle root is signed by the seller and inserted in a blockchain transaction. The tree structure allows selective disclosure of invoice data fields without having to disclose the whole invoice data. As discussed below, the tree structure can be used to achieve any of the six translucent design attributes discussed above.

Whilst the below examples focus on publishing data to blockchain, it can also be applied whenever data is notarised (hashed and signed). For example, the data in an e-passport is notarised by a national authority. This data could be stored in a Merkle tree as disclosed herein. In some examples, selective disclosure of data fields is enabled using the Merkle tree.

A Merkle tree can be used in some examples to provide all six attributes of a translucent database described above. However, in certain embodiments fewer than six of the attributes may be provided.

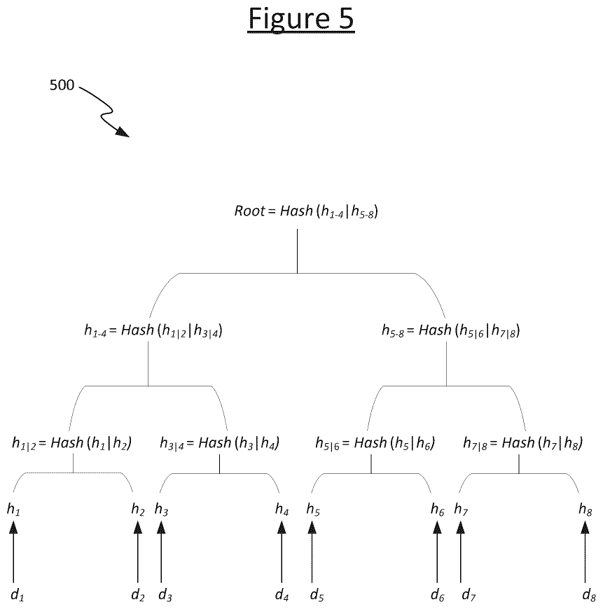

FIG. 5 shows an example Merkle tree 500. Given some data d, which may comprise sensitive data, the following example method may be used to construct a Merkle tree and in some cases to further publish the Merkle root in a blockchain transaction.

In a Merkle tree, Data d may be input in fields d₁, d₂, . . . , d_{T}. In the example of FIG. 5, T=8. In some examples, one or more of the data fields d₁, d₂, . . . , d_{T} may be generated based on another data field or from a random value. T may equal any value 2ⁿ where n is an integer value. Each data field may be hashed, and then each hash may be used as a leaf of a Merkle tree. If there are not enough leaves provided by the hashes, leaves may be repeated. Leaves may be repeated until there are enough leaves to fill the bottom tier of the Merkle tree. In the example of FIG. 5, leaves are repeated until 8 leaves are provided. Different repetition patterns may be used to repeat leaves, for example:
repeating an arbitrarily positioned leaf, for example the first leaf or last leaf;
repeating the leaves generated initially;
repeating leaves in certain positions of the Merkle tree (e.g., repeating the last and second last leaf of the Merkle three, repeating the first three leaves of the Merkle tree, etc.).

The root of the Merkle tree having a root value R may then be calculated. In examples where the transaction is stored on the blockchain, the root value R may be inserted into the blockchain transaction.

Authorised parties may store the data fields dᵢ of data d. Authorised parties may also store instructions for constructing the Merkle tree. The instructions may comprise information describing how to construct the Merkle tree. The instructions may comprise a number of leaf nodes used in the Merkle tree. The instructions may comprise a mapping of the data fields and corresponding hashes of the data fields to the leaf nodes of the Merkle tree. The instructions may comprise a description of the hashes used to generate the hashed values from respective data field. The instructions may comprise an indication of whether any of the nodes of the tree are used to flag that the Merkle tree comprises Misdirection, Quantization or Equivalence data (the use of these flags is described further below).

When there is a need to prove that the uploaded data included a particular value dᵢ=V, this can be done using Merkle proof, without having to reveal any other data fields. For example, the Merkle proof of d₄ is {h₃, h_{1|2}, h₅₋₈}.

By using a Merkle tree as described above, the translucent database design technique of Hashing is provided. Further, the translucent database design technique of Ignorance is provided, as data is hashed by authorized parties and not on a database or centralized server. Further, the translucent database design technique of Data Minimization is provided, since the tree structure allows a minimization of data required to be revealed when showing a particular value dᵢ=V.

To apply Misdirection, “fake” data (misdirection data) can be used to create a Merkle tree. The root value of the Merkle tree created using the fake data can be inserted in a blockchain transaction. To flag that the data is fake, one of the tree leaves is selected to be used as a flag. For example, the first leaf is the hash value of the string: ‘misdirection’, h₁=Hash(misdrection). Parties who have access to the tree pre-images know that the data is misdirection. An outside observer looking at transactions carrying Merkle tree roots cannot differentiate between fake and real data. It is possible to prove the data is misdirection by providing the Merkle proof of the flag leaf.

To hide that data is fake, the misdirection flag leaf can be hidden when providing Merkle proofs of other leaves. To do that we make sure that the pair leaf of the flag leaf is hash of a random value. In the example where the first leaf is the hash value of the string: ‘misdirection’, h₁=Hash (misdrection), the pair leaf h₂=Hash (rand). Then, considering an example for providing the Merkle proof of data field d₃, which will include h_{1|2}=Hash(h₁|h₂). If the range of h₂ was limited, it could be feasible to launch a brute force attack to find if h₁ is a misdirection flag. This is discussed further with respect to limited domain vulnerability below.

To apply Equivalence, sensitive data can be obscured with a similar value that is functionally equivalent. For example, a person's exact height is replaced with ‘short’, ‘average’, or ‘tall’. This technique can be applied by setting a leaf to the hash of the equivalent value, hᵢ=hash(\hat{d}ₗ), where \hat{d}ₗ is the equivalent value of dᵢ. Depending on the use case, sometimes it can be useful to include both values, \hat{d}ₗ dᵢ, in the tree. In this case, a leaf is set to hash(dᵢ) and another one is set to hash(\hat{d}ₗ).

To apply Quantization, reducing the precision of the numbers and values can be used to add privacy and security without destroying usability. A technique can be applied by dividing the data field into subfields dᵢ=d_{i|1}| . . . |d_{i|m}, where d_{i|1} holds the most significant bits (or less precise values), and dim holds the least significant bits. The hash of each subfield h_{i|j} can be set as a leaf in the tree. When it is desired to provide quantized values, d_{i|1} and its Merkle proof can be provided. When it is desired to provide the precise value, dᵢ=d_{i|1}| . . . |d_{i|m} and the Merkle proofs for these leaves can be provided.

Using a Merkle tree to store information on the blockchain as described above has many possible use cases. An example use case where invoices are published to the blockchain is now considered, however it should be noted that the method can be used to store any type of data other than invoices.

By publishing invoices on the blockchain, immutability of the blockchain can be used to ensure integrity of the invoice data record. The older this evidence becomes, the stronger integrity it gets. Keeping record of the purchased item description, terms, and conditions of sale, ensures that a seller and a buyer can protect their rights in cases of auditing, disagreements, or cancellation.

An example is now considered starting with a seller/website (a first party, Alice 103a) that uses blockchain to register purchase transactions and invoices. In this example, there are at least the following two actors:
1. Seller/online-shopping website (a first party, Alice 103a)
2. Customer/buyer (a second party, Bob 103a)

Alice 103a saves records of customer purchase orders and invoices on the blockchain. In some examples, customers pay for their purchases in bitcoin and the proof of payment and an invoice is recorded in the same blockchain transaction. Other suitable types of payment and transactions other than bitcoin may be used, however. In some examples, Alice 103a may have a digital certificate from a public key infrastructure (PKI) to prove the authenticity of her signature.

According to some examples, Alice 103a maps invoice data into a Merkle Tree and calculates a root value of the Merkle tree. Alice 103a may then sign the root value of the Merkle tree using her private key. Alice 103a may also sign payment related data using her private key. Alice 103a may then insert the signature, the signed message and optionally her certificate in a blockchain transaction. She leaves the input fields empty to create a transaction template and sends the incomplete transaction to the customer, Bob 103b. She may also send the invoice data fields to Bob 103b as well. Bob 103b may then run checks, fill the input fields completing the transaction and send the complete transaction back to Alice 103a or to the blockchain network. Alice 103a may then send the transaction to the blockchain network.

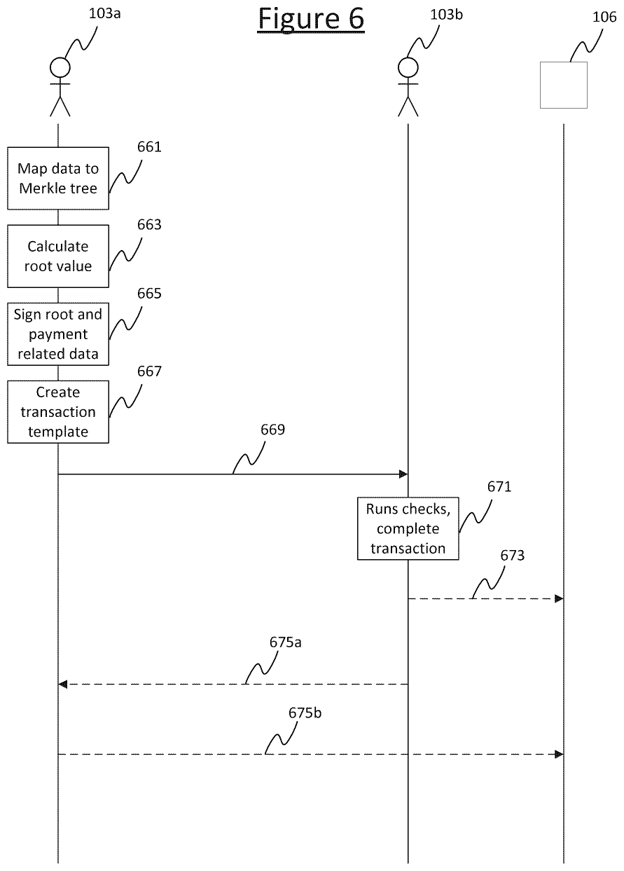

FIG. 6 shows an example method for publishing data d to a blockchain network 106. The data d may comprise invoice data, for example.

At 661, Alice 103a maps data d into a Merkle tree. Data d may comprise invoice data. In some examples, invoice data may comprise one or more of the following data fields (data items):
Seller Identification (for example, one or more of: name; contact; address; registration number; etc.);
Date of purchase;
Items purchased (for example, one or more of: details; description; quantity; price of individual items; etc.);
Method of payment;
Amount (for example, one or more of: total to be paid; tax; extra handling charges; discounts; etc.);
Terms of sale;
Invoice reference.

In a totally privacy preserving design, different fields of the invoice can be kept private. However, in cases of auditing or disputes, it is useful for revealing of selective invoice data fields.

One or more of the invoice data fields can be hashed separately to create a Merkle tree. A single root hash value R can be calculated for the tree.

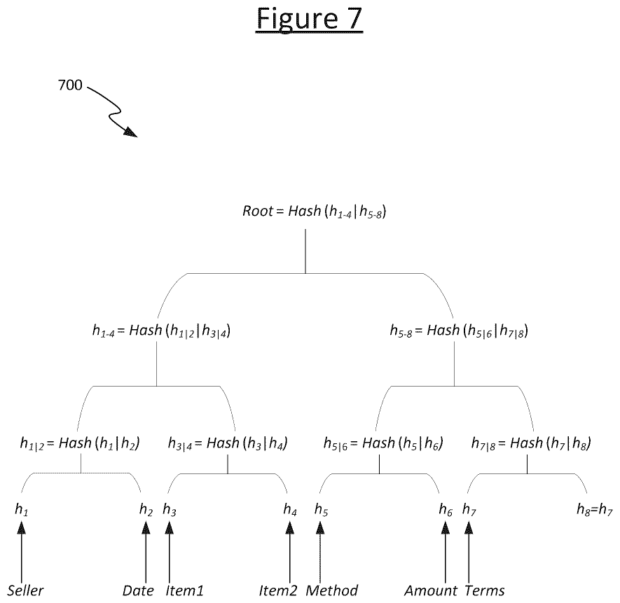

An example Merkle tree based on invoice data is shown in FIG. 7. In the example of FIG. 7, Bob 103b bought two items Item1 and Item2 in a transaction. The transaction may also include the following data fields: Seller data, Date data, Method data, Amount data and Terms data. Each of the invoice data fields can be hashed separately and mapped to a Merkle Tree to calculate a single hash value.

Assuming in an example that the seller bought two items as in FIG. 7, a Merkle tree could be formed as follows. For each invoice data field compute a hash hᵢ: h₁=Hash(Seller details), h₂=Hash(Date), h₃=Hash(purchased Item₁), h₄=Hash(purchased Item₂), h₅=Hash(pay method), h₆=Hash(amount), h₇=Hash(terms of sale), h₈=h₇.

At 661, a Merkle tree can be formed using the above computed hashes as the leaves and the tree root value can be calculated, as shown in FIG. 7. If the number of nodes in one level of the tree is odd, a copy of a particular node (e.g., a first node, a last node, etc.) can be added to make the number of nodes even. In this example, there are only 7 leaves so h₈ is added to set it to the value of h₇ to have an even number of leaves.

At 663, Alice 103a calculates the root value R of the Merkle tree.

At 665, Alice 103a signs the root value R of the Merkle tree using a private key belonging to Alice 103a. In some examples, Alice 103a may also sign payment related data using a private key belonging to Alice 103a—this may be the same key used to sign the root value or a different key. The payment related data may comprise, for example, a seller payment address (i.e., an address to paying Alice 103a). In some examples, the seller payment address may comprise a Bitcoin address.

At 667, Alice 103a creates a transaction template, TxID_{incomplete}. In an output of the transaction template, Alice 103a includes a root value, her signature (which may correspond to her private key) and her address (e.g., a payment address). The output may also comprise a certificate of her public key (i.e., the seller's public key infrastructure certificate).

Although it should be understood that there are many possible formats of the output, an example of the output may be:
OP_FALSE OP_RETURN<Root|seller_payment_address|seller's signature|seller's public key infrastructure certificate>

The seller may add, in a further output of the transaction template, her payment address and an amount for the transaction in Satoshi. An example transaction template is shown in Table 1.

TABLE 1
Incomplete transaction (a transaction template) sent from the seller to the buyer.
TxID_{incomplete}

| | | | |
|---|---|---|---|
| Version | 1 | Locktime | 0 |
| In-count | | Out-count | |

| | | Output list | |
|---|---|---|---|
| Input list | | Value in | |
| Outpoint | Unlocking script | Satoshi | Locking script |
| | | x | <SELLER_PAYMENT_ADDRESS> |
| | | 0 | OP_FALSE OP_RETURN |
| | | | <Invoice_data_Tree_Root \| |
| | | | SELLER_PAYMENT_ADDRESS \| |
| | | | SELLER_SIGNATURE \| |
| | | | SELLER_PKI_CERTIFICATE > |

In this example, the payment address of the seller is written twice in the transaction template, once after the OP_FALSE OP_RETURN, and once as a separate output. There are several other alternative ways to insert the data as discussed further below.

At 669, Alice 103a adds an output of her payment address and an amount (which may be e.g., in Satoshi). She sends Bob 103b: the incomplete transaction TxID_{incomplete}; the invoice data d; instructions on how to construct the Merkle tree of the invoice data and calculate the root value R.

At 671, Bob 103b may perform one or more checks before completing the transaction. Bob 103b may construct the Merkle tree based the invoice data and instructions on how to construct the Merkle tree received at 669. Bob 103b may then check the root value matches the value signed by Alice 103a.

Bob 103b may check that the Alice's signature and certificate are valid at 671. This may comprise checking that a public key infrastructure certificate of the signature of Alice 103a is valid. Bob 103b may check that the seller's payment addresses in the transaction template match.

If Bob 103b is satisfied with all checks at 671, Bob 103b may add an output locked to Bob 103b (e.g., a UTXO) to an unlocking script of the transaction template TxID_{incomplete} to provide transaction TxID_{complete}. An example transaction TxID_{complete} is shown in Table 2.

TABLE 2
A complete transaction TxID_{complete}. based on transaction template TxID_{incomplete}.
TxID_{complete}

| | | | |
|---|---|---|---|
| Version | 1 | Locktime | 0 |
| In-count | 1 | Out-count | 2 |

| | | Output list | |
|---|---|---|---|
| Input list | | Value in | |
| Outpoint | Unlocking script | Satoshi | Locking script |
| Buyer | BUYER_UNLOCKING | x | <SELLER_PAYMENT_ADDRESS> |
| UTXO | SCRIPT | 0 | OP_FALSE OP_RETURN |
| | | | <Invoice_data_Tree_Root \| |
| | | | SELLER_PAYMENT_ADDRESS \| |
| | | | SELLER_SIGNATURE \| |
| | | | SELLER_PKI_CERTIFICATE > |

After 671, Bob may send transaction TxID_{complete} to blockchain network 106 directly at 673 or may send transaction TxID_{complete} to Alice 103a at 675a who can then forward the transaction to blockchain network 106 at 675b. In some examples, in between 675a and 675b, Alice 103a may perform checks on transaction TxID_{complete}.

In the above example, the transaction template TxID_{incomplete} and the transaction TxID_{complete} include Alice's signature in an output, e.g. an unspendable output. For instance, Alice's signature may be proceeded by the opcodes OP_FALSE OP_RETURN. The signature is not verified during the transaction verification process and has to be separately verified Bob 103b at 671. In this way, the Alice's signature does not have to be an Elliptic Curve Digital Signature Algorithm (ECDSA) signature, as the digital certificate is verified by the Bob 103b anyway. Also, the payment of the transaction by Bob 103b is separated from the issuance of the invoice at 669 and Alice 103a does include extra inputs. In examples where Satoshis are used in the transaction, it is not required to burn Satoshis. Verification processing of the transaction with respect to a blockchain full node is also reduced. Furthermore, the signed data and the signature of Alice 103a can be separated and dealt with independently of the transaction. If Alice 103a wants to issue a copy of the invoice, the signed data would be an exact copy and her signature could be an exact copy, whereas that is not an option when locking script signature is used.

Alternative designs where the seller includes an input and unlocking script that uses a signature with a (single|Any one can pay) sig hash flag are considered, such as that shown in Table 3. A transaction template TxID_{incomplete} as shown in Table 3 can be created at 667 and sent at 669. A link between Alice's signature in the unlocking script and the Alice's identity (in this example provided in the PKI_Certificate) is provided, such that the signature in the unlocking script could only be generated by Alice 103a. At 671, Bob 103b checks the relationship between the public key of Alice 103a in the certificate and the one used in the unlocking script; i.e. the signature in the unlocking script could only be produced by the person named in the certificate. Bob 103b may not need to run an ECDSA signature verification algorithm. Bob 103b can also check that a correct sig-hash flag is used in Alice's signature.

TABLE 3
Incomplete transaction TxID_{incomplete} sent from the seller to the buyer.
The seller's unlocking script is used for signing inserted data.
TxID_{incomplete}

| | | | |
|---|---|---|---|
| Version | 1 | Locktime | 0 |
| In-count | | Out-count | |

| | | Output list | |
|---|---|---|---|
| Input list | | Value in | |
| Outpoint | Unlocking script | Satoshi | Locking script |
| Seller | Seller unlocking | Min Satoshi | <SELLER_PAYMENT_ADDRESS> |
| UTXO | script with sighash | | OP_RETURN <Invoice_data_Tree_Root \| |
| | flag (single \| Any | | SELLER_PKI_CERTIFICATE > |
| | one can pay) | | |
| | | Invoice total | <SELLER_PAYMENT_ADDRESS> |
| | | in Satoshi | |

In some examples, instead of having two outputs in the transaction as in Tables 1 to 3, it is possible to have only one output used for both. See Table 4. In such examples, Bob 103b may add an output locked to Bob 103b (e.g., a UTXO) and locking script at 671. A benefit of this system is that the invoice data and the payment are all included in one single output. However, this does not allow blockchain nodes to separate data from payment outputs. Note that the in transactions as in Table 4, the seller_payment_address occurs only once instead of twice as in Tables 1 to 3. The signed message could still be, for example:
Signed_Message=Hash(<SELLER_PAYMENT_ADDRESS>|<Invoice_data_tree_Root>)

TABLE 4
Incomplete transaction TxID_{incomplete} sent from the seller to the buyer.
A single output is used to carry data and receive payment
TxID_{incomplete}

| | | | |
|---|---|---|---|
| Version | 1 | Locktime | 0 |
| In-count | | Out-count | |

| | | Output list | |
|---|---|---|---|
| Input list | | Value in | |
| Outpoint | Unlocking script | Satoshi | Locking script |
| | | Invoice total in | <SELLER_PAYMENT_ADDRESS> |
| | | Satoshi | OP_RETURN |
| | | | <Invoice_data_Tree_Root \| |
| | | | SELLER_SIGNATURE \| |
| | | | SELLER_PKI_CERTIFICATE > |

In some examples such as the transaction TxID_{complete} in Table 5, instead of having one transaction that is used for payment and carrying invoice data, it is possible to have a transaction only for carrying invoice data. Payment can be done in a separate blockchain transaction or even using fiat. Unlinking the payment transaction and invoice data can be useful, in some examples, from a privacy point of view.

TABLE 5
Complete transaction TxID_{complete} sent by the seller to include invoice data
TxID_{complete}

| | | | |
|---|---|---|---|
| Version | 1 | Locktime | 0 |
| In-count | | Out-count | |

| | | Output list | |
|---|---|---|---|
| Input list | | Value in | |
| Outpoint | Unlocking script | Satoshi | Locking script |
| Seller | SELLER_UNLOCKING | Min Satoshi | <SELLER_PAYMENT_ADDRESS> |
| UTXO | SCRIPT | | OP_RETURN |
| | | | <Invoice_data_Tree_Root \| |
| | | | SELLER_SIGNATURE \| |
| | | | SELLER_PKI_CERTIFICATE > |

When storing data, Alice 103a and Bob 103b may store data off-chain. Alice 103a and Bob 103b may each store one or more of the following:
Data fields (e.g., invoice data fields);
At least one of the Merkle tree and instructions for generating it from the data fields;
At least one of: Raw transaction data or an identifier of the transaction (transaction ID);
Block height. This is to help locating the transaction within the blockchain.

Data may also be kept on-chain. Such data may include one or more of the following:
The root value R of the Merkle tree
Alice's signature.
Digital certificate that authenticates the Alice's signature.
Some data fields to be inserted in the transaction in clear text form. This could be for compliance, or to reduce complexity of proving invoice data fields (for example, data fields that are regularly accessed for auditing such as invoice total, invoice reference, and seller name)

The data kept on-chain may be sent from at least one of Alice 103a and Bob 103b.

Alice 103a or Bob 103b may then use selective reveal methods to share data fields in the data to prove that it is part of the Merkle tree. This can be shared and proved to third parties (or from Bob 103b to Alice 103a or vice versa). This can be performed without having to reveal other data fields. For example, in FIG. 7, the Merkle proof of Item1 where h₃=Hash(Item1) consists of proof=h₄, h_{1|2}, h₅₋₈. Therefore, by revealing Item1 and its proof the root can be calculated and checked that it matches the value inserted in the transaction.

If the input of a cryptographic hash function is chosen from limited domain, it may be possible to be found using dictionary attack. i.e., the attacker tries hashing all the domain values until a match is found. One way to circumvent such an attack is the use of salt, where Alice 103a adds a random value to the input of the hash. Alice 103a has to communicate the salt to the Bob 103b in such examples. In some examples, the salt can come from a large domain. In some examples, the salt is different for each leaf.

The dictionary attack vulnerability appears when sending the Merkle proof of a data field dᵢ, which is used to calculate leaf hᵢ=Hash(dᵢ). The proof includes the pair leaf of hᵢ, given by hᵢ₊₁=Hash(dᵢ₊₁). If dᵢ₊₁ is from limited domain, it can be easily cracked. In other words, when a prover tries to prove the inclusion of a leaf, its sibling leaf can be exposed if it comes from a limited domain.

To mitigate the above situation, in some examples each leaf of the tree is paired with a hash of a random value. Therefore, if the leaf hᵢ=Hash(dᵢ), then its pair leaf hᵢ₊₁=Hash(random( )). This doubles the number of the leaves of the Merkle tree but mitigates the vulnerability.

To apply Misdirection, Alice 103a can create transactions that resemble real transactions. For example, an invoice data tree (Merkle tree) could be created based on “fake” data not corresponding to a real transaction. An allocated leaf of the Merkle tree can be used to flag that the data used comprises fake, Misdirection data. The Misdirection data may comprise Misdirection data items. During any potential auditing process, Alice 103a can prove to authorised auditors that a misdirection flag is part of the signed data in the transaction, and therefore the transaction could be ignored. To outside observers, the transaction would look like any other transaction carrying an invoice. Assuming the misdirection data has a similar output to the output shown in Tables 1 and 2, if an outside observer was to see the transaction output of a transaction based on misdirection data they would see OP_FALSE OP_RETURN <Hash_value|SELLER_PAYMENT_ADDRESS|SELLER_SIGNATURE|SELLER_PKI_CERTIFICATE>.

There are several possibilities for indicating the use of Misdirection in a Merkle tree. For example, a specific leaf (e.g., first, last, nth) to be equal to hash(misdirection). This allows Alice 103a or Bob 103b to misdirect non-authorised entities during partial revealing of invoice data fields. As an example, if the specific leaf for flagging Misdirection is chosen as the first leaf in FIG. 5 or 7, h₁ may equal Hash (misdirection). This allows Alice 103a or Bob 103b to misdirect non-authorised entities during partial revealing of data fields, for example where h₃ onwards is used as invoice data fields. Note that the pair (h₂) of the misdirection flag leaf (h₁) may be a random value to make it harder to perform brute force attacks to calculate Hash(misdirection).

Another example for indicating the use of Misdirection in a Merkle tree is to concatenate invoice data hashes and a misdirection value, such that Hash_value=hash(random( )|misdirection).

To apply Equivalence to a Merkle tree, an equivalent value to a data field describing a property that is desired to be kept private can be determined and used. The equivalent value may be a functionally equivalent value to the data field. In some examples, descriptive terms may be used as functionally equivalent values to represent a numerical value in a data field, for example. The functionally equivalent value could be determined based on a range of values in which the property described in the private data field is in. For example, depending on a certain value in which height value is in, a functionally equivalent value can be determined. For example, 150 cm may be in a range of 145 cm to 160 cm which has a corresponding functionally equivalent value of “short”.

In some examples, a data field which is derided to be kept private (“a private data field”) and a functionally equivalent value to the private data field can both be inserted into the Merkle tree. Different access rights can be granted to each data field. In some examples, by keeping both the private data field and the functionally equivalent value in the Merkle tree, this can be used in examples where a buyer (e.g., Bob 103b) queries a product received after a transaction is stored on a blockchain network 106, the buyer can later be provided access for the private data to check the exact data provided by the seller (Alice 103a). In some examples, access to the private data field may be granted by Alice 103a to Bob 103b in situations where a dispute over a transaction arises. This can be achieved by having the exact value hashed and used as a leaf in forming the Merkle Tree. The equivalent value can also be included in another leaf of the Merkle Tree. In some examples, access to the private data as well as to the functionally equivalent value can be provided to one or more authorised validators to ensure that Alice provided a suitable functionally equivalent value to the private data.

In an example, a seller (e.g., a pharmacy, a sports equipment centre, etc.) requires a buyer's health profile to sell the buyer the required item (e.g., a prescription, customised sports equipment tailored to at least one of the weight and height of the buyer, etc.). The seller could use some of the leaves to include the hash of the exact values of the buyer's information and health profile, and some other leaves that include its equivalent values. The equivalent values could be used for research and auditing purposes. Both values could be used to validate that the correct equivalent values have been used by the seller.

In some examples, the leaf having a hash of the exact value may be paired with a hash of a random value. In some examples, the leaf having a hash of the functionally equivalent value may be paired with a hash of a random value.

The invoice tree can have one leaf having a hash of one or more exact values (these may be desired to be kept private) and another leaf that having a hash of the functionally equivalent value of the one or more exact values.

For example, depending on the weight and height of a user, a functionally equivalent value small, medium, large may be determined:
One leaf has the hash of the exact buyer measurements: hᵢ=Hash (weight|height).
Another leaf, hⱼ=Hash (equivalent class), that contains the equivalent class of this measurement, which can be Hash(small), Hash(medium), Hash(large), etc
   hᵢ may be paired with a hash of a random value, hᵢ₊₁. hⱼ may be paired with a hash of a random value, hⱼ₊₁.

For research and auditing purposes the seller could chose to reveal the equivalent class only (the pre-image of hⱼ). In cases of disputes the seller or the buyer may want to reveal the exact values (pre-image of hᵢ).

Quantization techniques can also be used to hide precise information in a Merkle tree. Information describing a property can be obtained and divided into information having at least two data items describing the property at different levels of precision. A set of data items for generating a Merkle tree can be determined or obtained including the least two data items describing the property at different levels of precision. Two or more leaf nodes of a Merkle tree can then be determined by hashing each data item in the set of data items, where the Merkle tree comprises a plurality of leaf nodes including the two or more leaf nodes. At least one of Alice 103a and Bob 103b may then store at least one the Merkle tree and the instructions for generating the Merkle tree.

An example where Quantization techniques are used to hide precision information for a shopper's privacy is considered. An example where a delivery service for the items purchased by the shopper is considered. A delivery address may be a property described by information (data) and may be included in data of an invoice, for example. Rather than including the delivery address in a single data field, a delivery address data item can be divided into further data, where each is hashed separately. For simplification let the delivery address comprise:
1. First line of address; Building number, flat number, street name, etc.
2. Code; postcode or zip code
3. Country

These three data items describe the property at different levels of precision. The delivery address property could be divided into these three data items. In an example, for the above data fields, the postcodes can be divided into two, and then each data field is hashed separately to provide:
h_{d1}=Hash (First line of address)
h_{d2}=Hash (1st half of postcode)
h_{d3}=Hash (2nd half of the postcode)
h_{d4}=Hash (country)

It will be appreciated that this is only an example of dividing information into different data items having different levels of precision. For the above information, the delivery service at the warehouse needs to know the country and 1st half of the postcode, i.e., the pre-image for h_{d2} and h_{d4}, which is enough to direct the delivery through the 1st leg. Whereas the driver carrying the final delivery leg would require access to the exact delivery address, i.e., the pre-image for h_{d1} and h_{d3}. For example, if the warehouse is in Manchester and the delivery is in London, the delivery service in Manchester needs only to know that they have a delivery to be sent to SW in Southwestern London. The driver carrying the last leg of the delivery could know that the delivery is destined for 10 Downing Street.

### Further Remarks

Other variants or use cases of the disclosed techniques may become apparent to the person skilled in the art once given the disclosure herein. The scope of the disclosure is not limited by the described embodiments but only by the accompanying claims.

For instance, some embodiments above have been described in terms of a bitcoin network 106, bitcoin blockchain 150 and bitcoin nodes 104. However, it will be appreciated that the bitcoin blockchain is one example of a blockchain 150 and the above description may apply generally to any blockchain. That is, the present invention is in by no way limited to the bitcoin blockchain. More generally, any reference above to bitcoin network 106, bitcoin blockchain 150 and bitcoin nodes 104 may be replaced with reference to a blockchain network 106, blockchain 150 and blockchain node 104 respectively. The blockchain, blockchain network and/or blockchain nodes may share some or all of the described properties of the bitcoin blockchain 150, bitcoin network 106 and bitcoin nodes 104 as described above.

In preferred embodiments of the invention, the blockchain network 106 is the bitcoin network and bitcoin nodes 104 perform at least all of the described functions of creating, publishing, propagating and storing blocks 151 of the blockchain 150. It is not excluded that there may be other network entities (or network elements) that only perform one or some but not all of these functions. That is, a network entity may perform the function of propagating and/or storing blocks without creating and publishing blocks (recall that these entities are not considered nodes of the preferred bitcoin network 106).

In other embodiments of the invention, the blockchain network 106 may not be the bitcoin network. In these embodiments, it is not excluded that a node may perform at least one or some but not all of the functions of creating, publishing, propagating and storing blocks 151 of the blockchain 150. For instance, on those other blockchain networks a “node” may be used to refer to a network entity that is configured to create and publish blocks 151 but not store and/or propagate those blocks 151 to other nodes.

Even more generally, any reference to the term “bitcoin node” 104 above may be replaced with the term “network entity” or “network element”, wherein such an entity/element is configured to perform some or all of the roles of creating, publishing, propagating and storing blocks. The functions of such a network entity/element may be implemented in hardware in the same way described above with reference to a blockchain node 104.

It will be appreciated that the above embodiments have been described by way of example only. More generally there may be provided a method, apparatus or program in accordance with any one or more of the following Statements.
Statement 1: A computer-implemented method comprising: obtaining information describing a property; dividing the information into at least two data items describing the property at at least two different levels of precision; obtaining a set of data items for generating a Merkle tree, the set of data items including the at least two data items; generating two or more leaf nodes of a Merkle tree by hashing each data item in the set of data items, wherein the Merkle tree comprises a plurality of leaf nodes including the two or more leaf nodes; and storing at least one of: the Merkle tree; instructions for generating the Merkle tree from the set of data items.
Statement 2: A method according to Statement 1, in obtaining the information describing the property comprises: based on a first value describing the property, determining a functionally equivalent value describing the property.
Statement 3: A method according to Statement 2, wherein the first value comprises a numerical value and the functionally equivalent value comprises a descriptive term, wherein the method comprises: determining the descriptive term by determining a numerical range containing the numerical value, wherein the descriptive term corresponds to the numerical range.
Statement 4: A method according to any preceding Statement, wherein the method comprises: computing a root value of the Merkle tree; signing the root value using a private key of a first party; and signing an address of a first party using the private key of the first party.
Statement 5: A method according to Statement 4, wherein the method comprises: creating a transaction template, the transaction template comprising an output comprising the root value, the address of the first party and a signature of the first party.
Statement 6: A method according to Statement 5, wherein the method comprises: sending, to a second party, the transaction template, the set of data items for generating the Merkle tree and instructions for generating the Merkle tree.
Statement 7: A method according to claim 6, wherein the method comprises: checking, by the second party, the validity of the signature; constructing, by the second party, a second Merkle tree having a second root value using the data for determining the Merkle tree and the instructions for generating the Merkle tree; checking that the second root value matches the root value signed by the first party; if the second root value matches the root value signed by the first party, adding an output locked to the second party to an unlocking script of the transaction template to complete the transaction; and sending, by the second party, the transaction to the first party or to the blockchain.
Statement 8: A method according to Statement 6 or Statement 7, wherein the output comprises a public key infrastructure certificate for the signature of the first party, and wherein the method comprises: prior to sending, by the second party, the transaction to the first party or to the blockchain: checking, by the second party, the validity of the public key infrastructure certificate for the signature of the first party.
Statement 9: A method according to Statement 7 or Statement 8, wherein the method comprises: sending, by the first party, the transaction to the blockchain.
Statement 10: A method according to any of Statements 5 to 9, wherein the method comprises sending by at least one of the first party and the second party, to the blockchain: the root value of the Merkle tree; and the signature of the first party.
Statement 11: A method according to any of Statements 7 to 9, the method comprising: storing, by the first party and the second party: the data item for determining the Merkle tree; at least one of: the Merkle tree and the instructions for generating the Merkle tree from the set of data items; at least one of: transaction data and an identifier of the transaction.
Statement 12: A method according to any preceding Statement, wherein the method comprises performing, by at least one of the first party and the second party: sharing, with a third party, a data field used for determining the Merkle tree; sending, to the third party, a Merkle proof of the data field.
Statement 13: A method according to any preceding Statement, wherein the method comprises: generating a set of misdirection data items; generating two or more leaf nodes of a further Merkle tree by hashing each data item in the set of misdirection data items; setting a leaf node in a specific position of the further Merkle tree to be a certain value to indicate that misdirection data items were used to generate the further Merkle tree; and storing the further Merkle tree, the further Merkle tree comprising a plurality of leaf nodes including the two or more leaf nodes.
Statement 14: A method according to any preceding Statement, wherein the set of data items includes one or more data items describing an invoice.
Statement 15: A method according to preceding Statement, wherein each leaf node generated by hashing one of the one or more data items describing an invoice is paired with a leaf node generated by hashing a random value.
Statement 16: Computer equipment comprising: memory comprising one or more memory units; and processing apparatus comprising one or more processing units, wherein the memory stores code arranged to run on the processing apparatus, the code being configured so as when on the processing apparatus to perform the method of any of Statements 1 to 15.
Statement 17: A computer program embodied on computer-readable storage and configured so as, when run on one or more processors, to perform the method of any of Statements 1 to 15.

According to another aspect disclosed herein, there may be provided a method comprising the actions of the first user.

According to another aspect disclosed herein, there may be provided a method comprising the actions of the second user.

According to another aspect disclosed herein, there may be provided a method comprising the actions of the first user and the second user.

According to another aspect disclosed herein, there may be provided a system comprising the computer equipment of the first user.

According to another aspect disclosed herein, there may be provided a system comprising the computer equipment of the second user.

According to another aspect disclosed herein, there may be provided a system comprising the computer equipment of the first user and the second user.

1. A computer-implemented method comprising:
obtaining information describing a property;
dividing the information into at least two data items describing the property at at least two different levels of precision;
obtaining a set of data items for generating a Merkle tree, the set of data items including the at least two data items;
generating two or more leaf nodes of a Merkle tree by hashing each data item in the set of data items, wherein the Merkle tree comprises a plurality of leaf nodes including the two or more leaf nodes; and
storing at least one of: the Merkle tree; instructions for generating the Merkle tree from the set of data items.

2. The method of claim 1, wherein obtaining the information describing the property comprises:
based on a first value describing the property, determining a functionally equivalent value describing the property.

3. The method of claim 2, wherein the first value comprises a numerical value and the functionally equivalent value comprises a descriptive term, wherein the method comprises:
determining the descriptive term by determining a numerical range containing the numerical value, wherein the descriptive term corresponds to the numerical range.

4. The method of claim 1, wherein the method comprises:
computing a root value of the Merkle tree;
signing the root value using a private key of a first party; and
signing an address of a first party using the private key of the first party.

5. The method of claim 4, wherein the method comprises:
creating a transaction template, the transaction template comprising an output comprising the root value, the address of the first party and a signature of the first party.

6. The method of claim 5, wherein the method comprises:
sending, to a second party, the transaction template, the set of data items for generating the Merkle tree and instructions for generating the Merkle tree.

7. The method of claim 6, wherein the method comprises:
checking, by the second party, a validity of the signature;
constructing, by the second party, a second Merkle tree having a second root value using the data for determining the Merkle tree and the instructions for generating the Merkle tree;
checking that the second root value matches the root value signed by the first party;
if the second root value matches the root value signed by the first party, adding an output locked to the second party to an unlocking script of the transaction template to complete the transaction; and
sending, by the second party, the transaction to the first party or to a blockchain.

8. The method of claim 6, wherein
the output comprises a public key infrastructure certificate for the signature of the first party, and wherein the method comprises:
prior to sending, by the second party, the transaction to the first party or to a blockchain:
checking, by the second party, a validity of the public key infrastructure certificate for the signature of the first party.

9. The method of claim 7, wherein
the method comprises:
sending, by the first party, the transaction to the blockchain.

10. The method of of claim 6, wherein the method comprises sending by at least one of the first party and the second party, to a blockchain:
the root value of the Merkle tree; and
the signature of the first party.

11. The method of claim 7, the method comprising:
storing, by the first party and the second party:
the data item for determining the Merkle tree;
at least one of: the Merkle tree and the instructions for generating the Merkle tree from the set of data items;
at least one of: transaction data and an identifier of the transaction.

12. The method of claim 6,
wherein the method comprises performing, by at least one of the first party and the second party:
sharing, with a third party, a data field used for determining the Merkle tree;
sending, to the third party, a Merkle proof of the data field.

13. The method of claim 1, wherein the method comprises:
generating a set of misdirection data items;
generating two or more leaf nodes of a further Merkle tree by hashing each data item in the set of misdirection data items;
setting a leaf node in a specific position of the further Merkle tree to be a certain value to indicate that misdirection data items were used to generate the further Merkle tree; and
storing the further Merkle tree, the further Merkle tree comprising a plurality of leaf nodes including the two or more leaf nodes.

14. The method of claim 1, wherein the set of data items includes one or more data items describing an invoice.

15. The method of claim 1, wherein each leaf node generated by hashing one of the one or more data items describing an invoice is paired with a leaf node generated by hashing a random value.

16. Computer equipment, comprising:
memory comprising one or more memory units; and
processing apparatus comprising one or more processing units, wherein the memory stores code arranged to run on the processing apparatus, the code being configured so as when run on the processing apparatus, the processing apparatus performs a method of:
obtaining information describing a property;
dividing the information into at least two data items describing the property at at least two different levels of precision;
obtaining a set of data items for generating a Merkle tree, the set of data items including the at least two data items;
generating two or more leaf nodes of a Merkle tree by hashing each data item in the set of data items, wherein the Merkle tree comprises a plurality of leaf nodes including the two or more leaf nodes; and
storing at least one of: the Merkle tree; instructions for generating the Merkle tree from the set of data items.

17. A computer program embodied on non-transitory computer-readable storage media and configured so as, when run on one or more processors, the one or more processors perform a method of:
obtaining information describing a property;
dividing the information into at least two data items describing the property at at least two different levels of precision;
obtaining a set of data items for generating a Merkle tree, the set of data items including the at least two data items;
generating two or more leaf nodes of a Merkle tree by hashing each data item in the set of data items, wherein the Merkle tree comprises a plurality of leaf nodes including the two or more leaf nodes; and
storing at least one of: the Merkle tree; instructions for generating the Merkle tree from the set of data items.
